(19) United States
(12) Patent Application Publication
(10) Pub. No.: US 2010/0225640 A1
(43) Pub. Date: Sep. 9, 2010

(54) Switching Operating Modes of Liquid Crystal Displays

(76) Inventors: Carlin J. Vieri, Menlo Park, CA (US); Rong C. Hwang, Taipei (TW); Mary Lou Jepsen, Sausalito, CA (US); John P. Ryan, Sausalito, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/628,974

(22) Filed: Dec. 1, 2009

Related U.S. Application Data
(60) Provisional application No. 61/156,880, filed on Mar. 3, 2009.

(51) Int. Cl. G06F 3/038; G09G 3/36

(52) U.S. Cl. 345/214; 345/87

(57) ABSTRACT

In an embodiment, a computer comprises a liquid crystal display (LCD) operable in a transmissive mode, a reflective mode, and a transflective mode; a display driver coupled to the LCD; one or more processors coupled to the display driver; mode switching logic coupled to the one or more processors and/or to the display driver; one or more electronic input sources coupled to the mode switching logic and providing input signals to the mode switching logic, wherein the input signals represent states of ambient conditions, other computer elements, user input, or user applications of the computer; and the mode switching logic is configured to cause the one or more processors to perform receiving one or more of the input signals; based on the input signals, selecting a particular operational mode for the LCD from among the transmissive mode, the reflective mode, and the transflective mode; causing the LCD to operate in the particular operational mode.

### CROSS-REFERENCE TO RELATED APPLICATIONS; BENEFIT CLAIM

This application claims the benefit of Provisional Application 61/156,880, filed Mar. 3, 2009, the entire contents of which is hereby incorporated by reference as if fully set forth herein, under 35 U.S.C. §119(e).

### FIELD OF THE INVENTION

The present invention relates to changing the operating modes of liquid crystal displays associated with computing devices or other electronic devices.

### BACKGROUND

The liquid crystal display (LCD) is widely used in computing devices and electronic devices such as laptop computers, netbook computers, cell phones, handheld computers, and various kinds of terminals and display units. Typically an LCD operates and is structured as a backlit transmissive display, reflective display, or transflective display. Less common are multi-mode displays that can operate in any of transmissive, reflective, or transflective modes.

Conventionally the appearance of a transmissive or transflective LCD can be changed only by adjusting the backlight intensity manually or in response to system power settings. For example, many personal computers provide keyboard controls that can be used to increase or decrease backlight intensity of an LCD attached to the computer. However, this adjustment does not change the panel mode; it simply dims the panel by changing the brightness of the backlight.

Some existing portable devices can adjust backlight intensity based on the output of an ambient light sensor (ALS) to provide an automatic dimming feature. More sophisticated devices may alter the video signal sent to the display as well as the backlight intensity based on the ALS to enhance the dynamic range of displayed images. Some existing display systems incorporate a spatially controllable backlight system. These systems are typically used for high dynamic range (HDR) applications. However, these approaches do not involve changing the operational mode of the display.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

In an embodiment, a computer comprises a liquid crystal display (LCD) operable in a transmissive mode, a reflective mode, and a transflective mode; a display driver coupled to the LCD; one or more processors coupled to the display driver; mode switching logic coupled to the one or more processors and to the display driver; one or more electronic input sources coupled to the mode switching logic and providing input signals to the mode switching logic; the input signals represent states of ambient conditions, other computer elements, user input, or user or system applications of the computer; and the mode switching logic is configured to cause the one or more processors to perform receiving one or more of the input signals; based on the input signals, selecting a particular operational mode for the LCD from among the transmissive mode, the reflective mode, and the transflective mode; causing the LCD to operate in the particular operational mode.

The term “electronic input sources” includes any one or more of a switch, a backlight intensity setting, an ambient light sensor, a power management subsystem, memory, and user and system applications, as further described herein. The term “states of ambient conditions, other computer elements, user input, or user or system applications of the computer” includes any one or more of ambient light levels; switch selections; backlight intensity selections; the name, type or function of one or more user or system applications; the state of a power management system or a power configuration; and values obtained from memory, all as further described herein.

In an embodiment, the one or more input sources comprises a pushbutton and the mode switching logic is configured to select the transmissive mode, the reflective mode, or the transflective mode in response to successive input signals from the pushbutton. In an embodiment, the one or more input sources comprises a backlight intensity state value, the one or more input signals indicate turning off a backlight of the LCD, and the particular operational mode is reflective mode.

In an embodiment, the one or more input sources comprises an ambient light sensor (ALS), and the mode switching logic is configured to cause the one or more processors to receive the input signals from the ALS indicating bright ambient light, to determine that a current operating mode of the LCD is the transmissive or transflective mode, and in response to the input signals and the current operating mode, to select and cause the LCD to operate in the reflective mode.

In an embodiment, the mode switching logic is configured, in response to the input signals and the current operating mode, to select and cause the LCD to operate in the transflective mode and to cause setting the backlight of the LCD to moderate brightness.

In an embodiment, the mode switching logic is configured to cause the one or more processors to receive the input signals from the ALS indicating an increase in the ambient light, and in response to the input signals, to cause setting the backlight either off or to greater brightness.

In an embodiment, the one or more input sources comprises an ambient light sensor (ALS), and the mode switching logic is configured to cause the one or more processors to generate and display, on the LCD, a message requesting user confirmation to perform a change to the particular operational mode of the LCD. In an embodiment, the one or more input sources comprises an ambient light sensor (ALS), and the mode switching logic is configured to cause modifying image data for one or more images displayed on the LCD in response to changes in ambient light as indicated by the input signals.

In an embodiment, the mode switching logic is configured to cause modifying the image data by causing any of switching to a different rendering mechanism, switching to a different sub pixel rendering process, switching to a different character smoothing process, altering the image data on a per-pixel basis, changing signal timing or a refresh rate of the LCD, or altering the image data on a per-sub pixel basis. In an embodiment, the mode switching logic is further configured to cause adjusting the brightness of the backlight of the LCD to maintain generally unchanged image quality in response to the changes in ambient light.

In an embodiment, the one or more input sources comprises a power management subsystem, and the mode switching logic is configured to cause the one or more processors to receive the input signals from the power management subsystem indicating a minimum power configuration, to determine that a current operating mode of the LCD is the transmissive mode, and in response to the input signals and the current operating mode, to select and cause the LCD to operate in the reflective mode.

In an embodiment, the one or more input sources further comprise an ambient light sensor (ALS), and the mode switching logic is configured to cause the one or more processors to receive the input signals from the ALS indicating bright ambient light and in response to the input signals from the ALS, to turn off the backlight of the LCD.

In an embodiment, the one or more input sources comprises a power management subsystem, and the mode switching logic is configured to cause the one or more processors to receive the input signals from the power management system indicating operation on battery power, to determine that a current operating mode of the LCD is the transmissive mode, and in response to the input signals and the current operating mode, to select and cause the LCD to operate in the reflective mode.

In an embodiment, the one or more input sources comprises a power management subsystem, and the mode switching logic is configured to cause the one or more processors to receive the input signals from the power management system indicating a low battery condition, to determine that a current operating mode of the LCD is the transmissive mode or transflective mode, and in response to the input signals and the current operating mode, to select and cause the LCD to operate in the reflective mode. In an embodiment, the one or more input sources comprises a power management subsystem, and the mode switching logic is configured to cause the one or more processors to receive the input signals from the power management system indicating a maximum performance power configuration, to determine that a current operating mode of the LCD is the reflective mode or transflective mode, and in response to the input signals and the current operating mode, to select and cause the LCD to operate in the transmissive mode.

In an embodiment, the one or more input sources comprises one or more values in non-volatile mode recall memory. In an embodiment, the mode switching logic is configured to determine that the computer has restarted, is restarting, has completed bootstrap loading or is in a bootstrap loading process, and in response, to fetch the values from the mode recall memory, to determine a previous operating mode of the LCD from the values, and to cause the LCD to operate in the previous operating mode.

In an embodiment, the one or more input sources comprise one or more user applications, or an operating system. In an embodiment, the one or more input sources comprises information identifying a name, type or function of one or more user applications hosted on the computer, and the mode switching logic is configured to select the particular operating mode for the LCD based on the name, type or function of the one or more user applications.

In an embodiment, the one or more input sources comprises information identifying a name, type or function of a selected window of a graphical user interface hosted on the computer, and the mode switching logic is configured to select the particular operating mode for the LCD based on the name, type or function of the selected window.

In an embodiment, the one or more input sources comprises information identifying a video user application hosted on the computer, and the mode switching logic is configured to select in response the transmissive mode as the particular operating mode. In an embodiment, the one or more input sources comprises information identifying a document reading application hosted on the computer, and the mode switching logic is configured to select in response a grayscale mode or a resolution enhancement or an alternate refresh rate of the LCD as the particular operating mode.

In an embodiment, the one or more input sources comprises information identifying a color image display application hosted on the computer, and the mode switching logic is configured to select in response the transmissive mode or the transflective mode as the particular operating mode. In an embodiment, the one or more input sources comprises information indicating that the user applications hosted on the computer are displaying both first output with limited color content and second output comprising grayscale text or data, and the mode switching logic is configured to select in response the transflective mode as the particular operating mode.

In an embodiment, the computer is any one of a laptop computer, netbook computer, cellular radiotelephone, electronic book reader, point of sale terminal, desktop computer, computer workstation, computer kiosk, or computer coupled to or integrated into a gasoline pump.

In an embodiment, the LCD is configured to permit individual addressing of transmissive sub pixel portions and reflective sub pixel portions of pixels of the LCD, the one or more input sources comprises information indicating that the user applications hosted on the computer are displaying both first output with limited color content and second output comprising grayscale text or data, and the mode switching logic is configured in response to cause driving a first part of the LCD in the transmissive mode or transflective mode and a second part of the LCD in the reflective mode.

In an embodiment, the mode switching logic is configured to delay causing the LCD to operate in the particular operational mode until after the LCD has completed displaying a current frame.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a computing device coupled to a multi-mode liquid crystal display;

FIG. 2 illustrates a computing device having user applications;

FIG. 3 illustrates a computing device having a backlight intensity control interfaced to processor(s);

FIG. 4 illustrates a computing device having an ambient light sensor interfaced to processor(s);

FIG. 5 illustrates a computing device having a power management subsystem interfaced to mode switching logic;

FIG. 6 illustrates a computing device having non-volatile mode recall memory interfaced to mode switching logic;

FIG. 7 illustrates a computer system with which some embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

In the present description, the term “computer” and “computing device 100” are used interchangeably. FIG. 1 illustrates a computing device 100 coupled to a multi-mode liquid crystal display 110. Example computing devices 100 useful in various embodiments include a laptop computer, netbook computer, cellular radiotelephone, electronic book reader, point of sale terminal, desktop computer, computer workstation, computer kiosk, or computer coupled to or integrated into a gasoline pump, and various other kinds of terminals and display units.

Using a multi-mode LCD 110 allows the display mode to better match viewing requirements than a conventional LCD. Embodiments provide techniques for switching between different modes of display, using a plurality of mechanisms and approaches. In an embodiment, a display mode of LCD 110 is switched manually by the user. In an embodiment, the display mode is switched automatically by the computing device or automatically by a subsystem of the computing device based on various data available to the subsystem or device. Other embodiments are described in other sections below.

Embodiments are useful with LCDs 110 that have multiple power, image quality, and high ambient readability modes, for example. One embodiment is useful with an LCD 110 that supports multiple operation modes. For example, in an embodiment the LCD 110 is capable of a conventional transmissive, full color mode. In this mode, the backlight is on and may be adjusted, colors are fully saturated, and the color gamut is at its maximum. Power consumption is primarily derived from backlight power. Further, LCD 110 also has a reflective, grayscale mode that may offer higher resolution than the full color mode. In this mode, the backlight is off, saving significant power. Ambient light such as sunlight or room light is reflected from the display to create images. The display shows monochrome grayscale images at a possibly increased resolution and possibly altered refresh rate compared to the transmissive mode. Alternatively, the reflective mode may also have some desaturated color available, if the reflective screen elements are covered partially or completely by color filters. In an embodiment, LCD 110 also can combine the preceding two modes in a transflective operational mode. In the transflective mode, the backlight is on, and typically is adjusted to a lower intensity, colors are desaturated but present, and the color gamut is reduced. Power is also reduced if the backlight intensity may be lowered.

In an embodiment, LCD 110 comprises a matrix or array of pixel structures 120 coupled to gate drivers 122 and source drivers 124. LCD 110 may also comprise a timing controller 125 or other electronic elements coupled to a display driver 104 of the computing device 100. In an embodiment, pixels in the LCD 110 are composed of both transmissive portions or sub pixels and reflective portions or sub pixels. The sub pixels may be independent or may be connected and controlled together.

In combination, how the sub pixels are driven, the ambient light intensity, and the backlight intensity collectively determine how an image is created on the display. How the sub pixels are driven includes particular digital pixel values that are sent to the display, details of digital to analog conversion, and the timing of how sub pixels are driven so that a different refresh rate is achieved. Altering some or all of these factors may be equivalent to switching display modes. Mode switching may be done to, among other things, alter the power consumption of the display system, target a particular image quality level in different environments, or provide a viewing experience appropriate for different applications.

Most displays currently available do not support the transflective and reflective modes described here, so no mode switching is required or feasible in such displays. Typical transflective displays are always in a transflective mode, and do not support either reflective or transmissive operation, so no mode switching is possible in such displays.

In an embodiment as seen in FIG. 1, computing device 100 comprises one or more processors 102, a display driver 104, an operating system 106 and mode switching logic 108. The one or more processors 102 comprise any of one or more central processing units (CPUs), CPU cores, microcontrollers, or microcomputer chipsets. Display driver 104 in conjunction with timing controller 125 comprises electronic circuits coupled to the one or more processors 102 and configured to receive data from the processors and to transform the data into driving signals for gate drivers 122 and source drivers 124. The amplitude, timing, and other parameters of the driving signals may vary under control of the processors 102.

Mode switching logic 108 comprises one or more circuits, firmware, software instructions in memory, or a combination thereof that is configured to implement the techniques described herein for receiving input, determining an operational mode, and selectively changing the operational mode of the LCD 110 to any one or more modes selected from among transmissive, reflective, and transflective, as further described in the following sections. In one embodiment as in FIG. 1, mode switching logic 108 is depicted as coupled through operating system 106 to processor 102. Alternatively, mode switching logic 108 may connect directly to the LCD 110 or display driver 104

Direct User Control

In an embodiment, an end user of computing device 100 may directly control selection of an operational mode of LCD 110. If the user is outdoors in bright sunlight or in another high ambient light environment, the transmissive mode may not be readable, so the user may decide to switch to the reflective or transflective mode.

In various embodiments, selecting an operational mode may be done using a physical button or switch or via software application or some other means of control. Switching modes may be done simply by setting existing backlight intensity controls to “off” or a very low level. It may also be done by using dedicated controls to switch between reflective (or transflective) modes and purely transmissive modes, as well as controlling the backlight.

In one embodiment shown in FIG. 1, a switch 112 is coupled to an interface 114, which is coupled directly or indirectly to processor 102 or to associated I/O logic. Alternatively, switch 112 and interface 114 are coupled directly to the backlight 126. In another alternative, switch 112 and interface 114 are coupled to the LCD 110 through display driver 104. Switch 112 may comprise, in various embodiments, a single-pole single-throw SPST momentary pushbutton, a multi-position slide switch, a rotary switch, or another form of switch. With an SPST pushbutton, the response to a user depressing or closing the switch signals the mode switching logic 108 that a mode switch request has been received. When the switch and interface are coupled to the processor 102, call-back techniques may be used to accomplish the signaling, but use of the processor or such techniques is not required in all embodiments.

In response, mode switching logic 108 toggles to a next display mode, and signals display driver 104 to change the display signals driven to LCD 110 to accomplish a mode change. For example, mode switching logic 108 may signal display driver 104 to turn the backlight 126 of LCD 110 on or off, or to drive data only to transmissive sub pixels of pixel structures 120, or to drive data only to the reflective sub pixels, or to drive both the transmissive and reflective sub pixels, depending on the selected mode. Optionally, signals or data values representing the selected mode may be stored in memory.

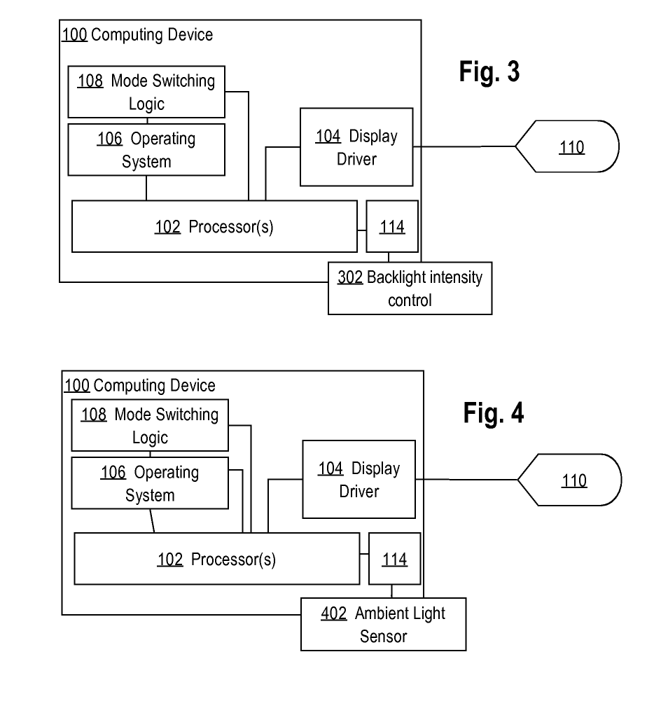

FIG. 3 illustrates a computing device having a backlight intensity control 302 interfaced to processor(s). In an embodiment, backlight intensity control 302 comprises one or more pushbuttons or keyboard hotkeys coupled to an interface 114, which is coupled directly or indirectly to processors 102. In an embodiment, backlight intensity control 302 may comprise buttons or switches that are mounted on LCD 110. In a typical arrangement, user operation of one of the buttons triggers display driver 104 to signal the LCD 110 to dim the backlight 126 by a discrete amount, and operation of another button triggers brightening the backlight 126.

Alternatively when the backlight intensity control 302 is integrated into LCD 110, the backlight intensity may be coupled to the timing controller 125 and an LED driver circuit, resulting in more direct dimming or brightening of the LCD. In either embodiment, successive operation of the “dim” button eventually results in turning off the backlight 126, which is equivalent to switching to reflective mode. As the LCD 110 is multi-mode, turning off the backlight 126 enables the LCD to operate in reflective mode under appropriate ambient light conditions.

Automatic Mode Switching

Switching display modes may also be done under the control of the computing system based on the illumination environment or a dedicated subsystem that deals with the illumination environment. FIG. 4 illustrates the computing device 100 having an ambient light sensor (ALS) 402 interfaced to the processor(s) 102. The ALS is configured to sense ambient light in the environment around the computing device and to generate a signal to the processors and/or to the mode switching logic 108 indicating a relative light level.

In various embodiments, ALS 402 may comprise any of optical detectors such as quantum devices in which an individual photon produces a discrete effect; photo resistors or Light Dependent Resistors (LDR) which change resistance according to light intensity; photovoltaic cells or solar cells which produce a voltage and supply an electric current when illuminated; photodiodes which can operate in photovoltaic mode or photoconductive mode; phototransistors incorporating one of the above sensing methods; or LEDs that are reverse-biased to act as photodiodes.

ALS 402 is indirectly coupled to mode switching logic 108, which is configured in this embodiment to respond to signals from the ALS by changing the display mode of the LCD 110. Alternatively, mode switching logic 108 may respond by generating an interrupt, software event, message or other signal to the operating system 106 or to a hosted application, so that the computing device 100 can prompt an end user to approve a proposed change in display mode.

For example, in response to signals from the ALS 402, mode switching logic 108 or operating system 106 or another element of system software or an application may determine that the ambient light is too bright for the transmissive mode to be easily or usefully readable. In response, the mode switching logic 108, operating system 106 or software may automatically enable the LCD 110 to switch to a reflective mode.

In an embodiment, in response to and depending on the kind, magnitude or nature of signals from the ALS 402, the mode switching logic 108 is configured to implement a range of settings for LCD 110. For example, when signals from ALS 402 indicate moderately bright ambient light, mode switching logic 108, operating system 106 or software may set the LCD 110 in transflective mode with a partly dimmed backlight 126. As signals from ALS 402 indicate that the ambient light has become brighter, the mode switching logic 108, operating system 106 or software may be configured to cause the backlight 126 output to increase to maintain consistent image characteristics, or the backlight may be turned off if the ambient light is too bright for the transmissive portion of the LCD 110 to be legible. When signals from ALS 402 indicate extremely dim ambient light, such as during nighttime use, the mode switching logic 108, operating system 106 or software may be configured to cause the backlight to turn on at a low level.

In an embodiment, an end user can override the system display mode settings. For example, the embodiment of FIG. 4 may be combined with the embodiments of FIG. 3 and/or FIG. 1, enabling a user to operate switch 112 or backlight intensity control 302 to manually change the operational mode of LCD 110 when the mode switching logic 108, operating system 106 or software have caused the operational mode to change to an undesirable state in response to signals from ALS 402.

Additionally or alternatively, the mode switching logic 108, operating system 106 or software may be configured to generate a prompt message on LCD 110 before implementing a change in operational mode in response to signals from ALS 402. For example, the mode switching logic 108, operating system 106 or software may be configured to drive a character generator in display driver 104 that superimposes a prompt message over any image that is then currently displayed on LCD 110. User input may be received to confirm or dismiss the proposed change in operational mode. For example, in response to a superimposed prompt message, the user could strike the ESCAPE key of keyboard 101, or press a specified or dedicated switch on the LCD 110 that provides an override function.

In an embodiment, the image data that is sent to the display is modified or adjusted by the mode switching logic 108, operating system 106 or software in response to signals from the ALS 402. Modifying or adjusting image data may be performed additionally to or alternatively to adjusting intensity of the backlight 126 based on signals from ALS 402.

Modifying or adjusting image data may involve several approaches. For example, modifying or adjusting image data may comprise selecting a different character rendering process, selecting a different resolution of character or image rendering, sub pixel rendering process, character smoothing process, or other visual effect, so that the driving signals communicated from display driver 104 to LCD 110 are different given the same input data. For example, if the mode switching logic 108, operating system 106 or software determines, in response to signals from the ALS 402, to change the operating mode of LCD 110 to reflective, then the resulting generally monochrome or gray-scale display may benefit from switching to a different rendering process at the same time. To perform a change in rendering or otherwise modifying or adjusting image data, the mode switching logic 108, operating system 106 or software may form and send instructions to a graphical processing unit (GPU) in the computing device 100 that is responsible for rendering data and generating driving signals for the LCD 110.

Modifying or adjusting image data also may involve changing the timing of how sub pixels are driven, so that a different refresh rate is achieved. For example, the mode switching logic 108 may be configured to instruct the timing controller 125 to adopt a different clock rate or to deliver clock signals, other timing signals, or other control signals to the LCD 110 in a different way. Consequently, the refresh rate of LCD 110 may be changed in response to changing ambient light conditions or other factors. For example, when the LCD 110 is to be used with a reading application, lower power consumption may be achieved by switching to a low refresh rate.

In an embodiment, the mode switching logic 108, operating system 106 or software may be configured to use a combination of image adjustment and backlight adjustment to maintain a particular level of image quality across a range of ambient luminance values. Adjusting the image data at a fixed backlight level may allow image quality to be maintained as ambient illumination changes without increasing power consumption.

In an embodiment, LCD 110 is configured to independently address the reflective and transmissive portions of a pixel. In this embodiment, the mode switching logic 108, operating system 106 or software may be configured to alter the data sent to the LCD 110 on a per-sub pixel basis, in addition to or as an alternative to modifying data per pixel. Altering data on a sub pixel basis allows the mode switching logic 108, operating system 106 or software to adjust the contribution of the transmissive and reflective parts of the pixel to the overall image as a function of ambient and backlight intensity based on signals from ALS 402 and the intensity setting of backlight 126. Image quality, power consumption, or “viewability” may be improved based on these adjustments.

If the ALS 402 indicates a low ambient environment, the mode switching logic 108, operating system 106 or software may be configured to turn the backlight 126 on to exit the reflective mode if not enough light falls on the LCD 110 to allow readability in reflective mode.

Mode Switching Based on System Power Settings

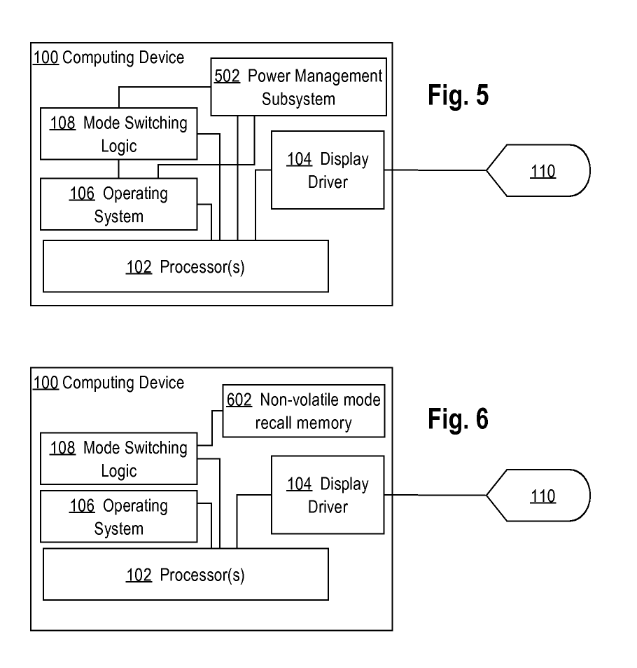

FIG. 5 illustrates the computing device 100 having a power management subsystem 502 interfaced to mode switching logic 108 and to processor(s) 102. In an embodiment, the operation mode of LCD 110 also may be switched based on system power settings, with or without the contribution of information from ALS 402 (FIG. 4).

In the embodiment of FIG. 5, power management subsystem 502 can receive user input through operating system 106 indicating a user selection of one of a plurality of power operating characteristics. In one embodiment, power management subsystem 502 comprises or is coupled to the power supply, battery, power converter or other power elements of computing device 100, and operates under control of operating system 106, a software application hosted on the operating system, or firmware. The operating system, software application or firmware can interact with a graphical user interface (GUI) or other display capability of the computing device 100 to present power management options to a user and receive user input selecting power management parameter settings. For example, the power management subsystem 502 may cause a power management icon to be displayed in a “system tray” area of the GUI or to be displayed in a pop-up window in response to user selection of a particular keyboard key, icon, or other display element. Selecting the icon or displaying the pop-up window presents the user with a list of available power configurations. Example power configurations include “minimum power” and “maximum performance.”

In an embodiment, if the user selects a “minimum power” configuration, then in response, the mode switching logic 108, operating system 106 or software may be configured to dim the backlight 126 and enable the transflective mode of LCD 110, or switch the backlight off entirely if signals from ALS 402 indicate that enough ambient light is available for viewing in reflective mode. Further, in an embodiment the mode switching logic 108 may be configured to instruct the timing controller 125 to adopt a different clock rate or to deliver clock signals, other timing signals, or other control signals to the LCD 110 in a different way; so that when the LCD 110 is to be switched to reflective mode for a reading application, lower power consumption may be achieved by switching to a low refresh rate.

Alternatively, if the user selects a “maximum performance” mode, the mode switching logic 108, operating system 106 or software may be configured to set the backlight 126 to full brightness and enable the purely transmissive mode of LCD 110. Intermediate settings are also possible.

The mode switching logic 108, operating system 106 or software may be configured to change the operational mode of LCD 110 if the computing device 100 begins or ends operating on battery power. For example, the mode switching logic may receive input signals from the power management system indicating operation on battery power, determine that a current operating mode of the LCD is the transmissive mode, and in response to the input signals and the current operating mode, select and cause the LCD to operate in the transflective mode. Alternatively, the mode switching logic may receive the input signals from the power management system indicating a low battery condition, determine that a current operating mode of the LCD is the transmissive mode or transflective mode, and in response to the input signals and the current operating mode, select and cause the LCD to operate in the reflective mode.

Mode Storage and Recall

In an embodiment, computing device 100 is configured to recall which display mode was used and restore that mode across power cycles. Mode recall may be subject to system override if the viewing environment or application has changed since the system was last switched on.

FIG. 6 illustrates a computing device 100 having non-volatile mode recall memory 602 interfaced to the mode switching logic 108. In an embodiment, mode switching logic 108 is configured to store data identifying a current display mode in memory 602 and to update the data in the memory each time that the mode switching logic causes the display mode to change.

In an embodiment, upon power-up or upon restart, the computing device 100 executes a bootstrap loading sequence that includes signaling the mode switching logic 108 that a bootstrap event is occurring. In response, the mode switching logic 108 fetches the stored mode data from memory 602 and instructs or causes display driver 104 to set the LCD 110 to a display mode corresponding to the fetched stored mode data.

The embodiment of FIG. 6 may be used in combination with the embodiment of FIG. 5. The mode switching logic 108 also may be configured to retrieve a current power configuration from other memory that is managed by power management system 502, and to instruct or cause display driver 104 to set the LCD 110 to a display mode that is determined at the time of bootstrap loading based on the power configuration that was retrieved.

Mode Switching Based on Computer Applications

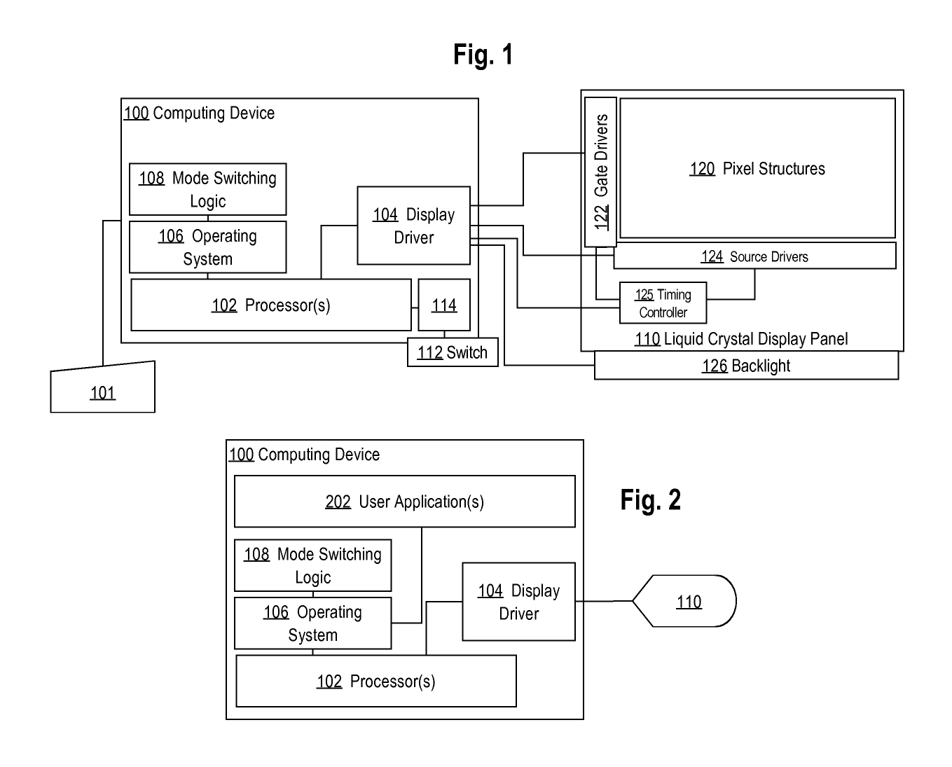

FIG. 2 illustrates a computing device configured with one or more user applications 202 hosted by or controlled by operating system 106. User applications 202 broadly represents, for various embodiments, digital logic circuits such as FPGAs or ASICs that embody particular computing applications; firmware such as ROM or EPROM that have been programmed with particular computing applications; or instructions stored in volatile memory and executed under control of the operating system 106. The user applications 202 may support any useful computing function such as business applications, video or graphics, financial applications, retail store applications, word processing, or any other user task.

In an embodiment, mode switching logic 108 is configured to poll or query the user applications 202 or operating system 106, or receive events or messages from the user applications or operating system 106, to obtain identifying information about the user applications. For example, mode switching logic 108 might install an interrupt handler or other extension to operating system 106 that causes the operating system to signal the mode switching logic 108 when a new user application 202 is launched. Alternatively, the mode switching logic 108 is notified or signaled when a different user application becomes selected as an active window among a plurality of windows of a graphical user interface that the operating system manages. The particular mechanism by which the mode switching logic 108 becomes aware of the identity, type, or function of user applications 202 is not critical.

In the embodiment of FIG. 2, the display mode for LCD 110 may be set by, or on the basis of, the user applications 202 running on the computing device 100. For example, a full color gamut mode may be desirable when one of the user applications 202 is displaying video content.

Additionally or alternatively, if the reflective mode of LCD 110 offers a resolution enhancement, the resolution enhancement may be selected when the mode switching logic 108 determines that one of the user applications 202 is displaying black and white text. Additionally or alternatively, some users may prefer to read text documents in a grayscale mode, and the mode switching logic 108 may be configured to switch the LCD 110 into grayscale mode when the mode switching logic determines that one of the user applications 202 is displaying a text document, or that the user application is a document editing application or document reading application.

Additionally or alternatively, the mode switching logic 108 may be configured to switch the LCD 110 into transmissive or transflective mode if the mode switching logic determines that the user applications 202 are displaying color images.

Additionally or alternatively, the mode switching logic 108 may be configured to switch the LCD 110 in transflective mode in response to determining that the user applications are displaying charts, graphs or other output with limited color content alongside grayscale text or data.

Structure of Mode Switching Logic

The mode switching logic 108 may implement decision logic using any of several mechanisms in various embodiments. In one embodiment, mode switching logic 108 is programmed or electronically structured to implement a decision tree in which a sequence of observations about power state, application type, ambient light condition, or others result in a determination of the screen mode. Based on the results of applying known observational data to the decision tree, mode switching logic 108 determines an operational mode for LCD 110 and instructs or causes display driver 104 to set the LCD 110 to the selected mode.

Alternatively, mode switching logic 108 is programmed or electronically structured to implement a state table in which each pre-determined combination of power state, applications, ambient light condition, etc., corresponds to a specified screen mode. Based on the results of looking up known observational data values in the state table, mode switching logic 108 determines an operational mode for LCD 110 and instructs or causes display driver 104 to set the LCD 110 to the selected mode.

TABLE 1 is an example of a state table; the display mode determinations are hypothetical and could be different in various embodiments depending on display performance, application requirements, or other issues. Further, TABLE 1 is not intended to exhaustively cover all combinations of all conceivable parameters and resulting display determinations; it is an example showing how some particular input parameters might be combined in mode switching logic 108 to result in selecting one of a plurality of display modes for LCD 110 with associated changes in rendering, backlight intensity, or other output parameters.

TABLE 1
EXAMPLE STATE TABLE FOR MODE SWITCHING LOGIC

| Backlight | | | | |
|---|---|---|---|---|
| Intensity | | Ambient | | |
| Control | Power | Light | User | Display |
| State | State | Level | Application | Mode |
| Off | Line | High | Text | Reflective |
| Moderate | Line | Moderate | Text | Transflective |
| High | Line | Low | Text | Transmissive, |
| | | | | rendering |
| | | | | optimized for |
| | | | | color fonts |
| Moderate | Battery | High | Video | Transflective |
| High | Battery | Moderate | Video | Transmissive |
| High | Battery | Low | Video | Transmissive |
| Partly | Line | Moderate | Graphics | Transflective |
| dimmed | | | | |
| Off | Line | High | Graphics | Reflective |
| Moderate | Battery | Low | Graphics | Transflective |
| Moderate | Line, minimum | Low | Mixed | Transflective |
| | power profile | | | |
| Off | Line, minimum | High | Mixed | Reflective |
| | power profile | | | |
| High | Line, maximum | Low | Mixed | Transmissive |
| | performance | | | |
| | profile | | | |

In other embodiments, state machines, procedural logic using conditional constructs such as “IF . . . THEN” statements, or other mechanisms may be used.

Multiple Concurrent Modes

In an embodiment, mode switching logic 108 is configured to cause LCD 110 to operate in more than one operational mode at a time. Multi-mode operation is possible in an LCD 110 in which pixel structures 120, gate drivers 122 and source drivers 124 are configured to permit individual addressing of transmissive pixel portions and reflective pixel portions, or with partial backlight illumination as noted below. For example, LCD 110 may be constructed as disclosed in co-pending US patent application No. Number, filed on Date, Attorney Docket No. 60203-0029.

In one embodiment, when mode switching logic 108 determines that the LCD 110 is displaying black and white text alongside color images, for example, in response to receiving data or messages from user applications 202 or operating system 106, then the mode switching logic may cause driving part of the display in an enhanced resolution reflective grayscale mode for better display of text images, and may cause driving part of the display in a transflective mode for displaying color images, possibly with a reduced gamut of colors.

In an embodiment in which the backlight illumination system can be controlled to illuminate only portions of the screen, then power savings may be realized by configuring the mode switching logic 108 to instruct the LCD 110 or display driver 104 to cause only the transflective or transmissive parts of the screen to receive backlight illumination.

Limiting Mode Changes Based on Image Quality

In any of the foregoing embodiments, mode switching logic 108 or display driver 104 may be configured to allow mode changes only when the change would not result in potentially objectionable image artifacts.

For example, mode switching logic 108 may be configured to direct the LCD 110 to change modes at any point in the display refresh cycle, but the display driver 104 may be configured to wait to implement a mode change until the LCD has completed displaying the current frame of video data. Alternatively, mode switching logic 108 may be electronically interfaced to a timing controller (TCON) of the LCD 110 so that the mode switching logic can monitor timing signals and issue mode change instructions or signals only at a time in the display cycle that will not cause creating objectionable display artifacts.

Hardware Overview

According to one embodiment, the techniques described herein are implemented by one or more special-purpose computing devices 100. The special-purpose computing devices 100 may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

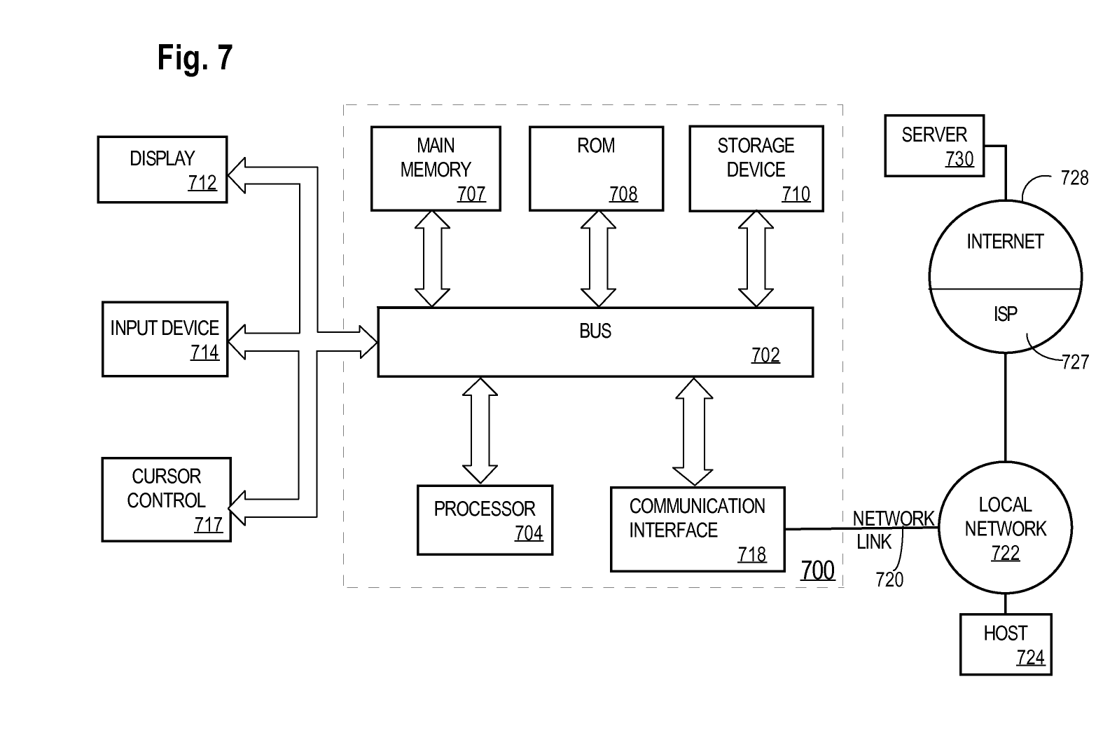

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer comprising:
a liquid crystal display (LCD) operable in a transmissive mode, a reflective mode, and
a transflective mode;
one or more processors coupled to the LCD;
mode switching logic coupled to the LCD;
one or more electronic input sources coupled to the mode switching logic and providing input signals to the mode switching logic, wherein the input signals represent states of ambient conditions, other computer elements, user input, or user or system applications of the computer;
wherein the mode switching logic is configured to perform:
receiving one or more of the input signals;
based on the input signals, selecting a particular operational mode for the LCD from among the transmissive mode, the reflective mode, and the transflective mode;
causing the LCD to operate in the particular operational mode.

2. The computer of claim 1, wherein the one or more input sources comprises a pushbutton and wherein the mode switching logic is configured to select the transmissive mode, the reflective mode, and the transflective mode in response to successive input signals from the pushbutton.

3. The computer of claim 1, wherein the one or more input sources comprises a backlight intensity state value, the one or more input signals indicate turning off a backlight of the LCD, and the particular operational mode is reflective mode.

4. The computer of claim 1, wherein the one or more input sources comprises an ambient light sensor.

5. The computer of claim 1, wherein the one or more input sources comprises an ambient light sensor (ALS), and wherein the mode switching logic is configured to cause the one or more processors to receive the input signals from the ALS indicating bright ambient light, to determine that a current operating mode of the LCD is the transmissive or transflective mode, and in response to the input signals and the current operating mode, to select and cause the LCD to operate in the reflective mode.

6. The computer of claim 1, wherein the one or more input sources comprises an ambient light sensor (ALS), and wherein the mode switching logic is configured to cause the one or more processors to receive the input signals from the ALS indicating moderately bright ambient light, to determine that a current operating mode of the LCD is the transmissive mode or reflective mode, and in response to the input signals and the current operating mode, to select and cause the LCD to operate in the transflective mode and to cause setting a backlight of the LCD to moderate brightness.

7. The computer of claim 6, wherein the mode switching logic is configured to cause the one or more processors to receive the input signals from the ALS indicating an increase in the ambient light, and in response to the input signals, to cause setting the backlight either off or to greater brightness.

8. The computer of claim 1, wherein the one or more input sources comprises an ambient light sensor (ALS), and wherein the mode switching logic is configured to cause the one or more processors to generate and display, on the LCD, a message requesting user confirmation to perform a change to the particular operational mode of the LCD.

9. The computer of claim 1, wherein the one or more input sources comprises an ambient light sensor (ALS), and wherein the mode switching logic is configured to cause modifying image data for one or more images displayed on the LCD in response to changes in ambient light as indicated by the input signals.

10. The computer of claim 1, wherein the mode switching logic is configured to cause modifying the image data by causing any of switching to a different rendering mechanism, switching to a different sub pixel rendering process, switching to a different character smoothing process, altering the image data on a per-pixel basis, changing signal timing or a refresh rate of the LCD, or altering the image data on a per-sub pixel basis.

11. The computer of claim 10, wherein the mode switching logic is further configured to cause adjusting a brightness of a backlight of the LCD to maintain generally unchanged image quality in response to the changes in ambient light.

12. The computer of claim 1, wherein the one or more input sources comprises a power management subsystem.

13. The computer of claim 1, wherein the one or more input sources comprises a power management subsystem, and wherein the mode switching logic is configured to cause the one or more processors to receive the input signals from the power management system indicating a minimum power configuration, to determine that a current operating mode of the LCD is the transmissive mode, and in response to the input signals and the current operating mode, to select and cause the LCD to operate in the reflective mode.

14. The computer of claim 13, wherein the one or more input sources further comprise an ambient light sensor (ALS), and wherein the mode switching logic is configured to cause the one or more processors to receive the input signals from the ALS indicating bright ambient light and in response to the input signals from the ALS, to turn off a backlight of the LCD.

15. The computer of claim 1, wherein the one or more input sources comprises a power management subsystem, and wherein the mode switching logic is configured to cause the one or more processors to receive the input signals from the power management system indicating operation on battery power, to determine that a current operating mode of the LCD is the transmissive mode, and in response to the input signals and the current operating mode, to select and cause the LCD to operate in the reflective mode.

16. The computer of claim 15, wherein the mode switching logic is further configured to cause a change in a refresh rate of the LCD.

17. The computer of claim 1, wherein the one or more input sources comprises a power management subsystem, and wherein the mode switching logic is configured to cause the one or more processors to receive the input signals from the power management system indicating a low battery condition, to determine that a current operating mode of the LCD is the transmissive mode or transflective mode, and in response to the input signals and the current operating mode, to select and cause the LCD to operate in the reflective mode.

18. The computer of claim 1, wherein the one or more input sources comprises a power management subsystem, and wherein the mode switching logic is configured to cause the one or more processors to receive the input signals from the power management system indicating a maximum performance power configuration, to determine that a current operating mode of the LCD is the reflective mode or transflective mode, and in response to the input signals and the current operating mode, to select and cause the LCD to operate in the transmissive mode.

19. The computer of claim 1, wherein the one or more input sources comprises one or more values in non-volatile mode recall memory.

20. The computer of claim 1, wherein the one or more input sources comprises one or more values in non-volatile mode recall memory, and wherein the mode switching logic is configured to determine that the computer has restarted, is restarting, has completed bootstrap loading or is in a bootstrap loading process, and in response, to fetch the values from the mode recall memory, to determine a previous operating mode of the LCD from the values, and to cause the LCD to operate in the previous operating mode.

21. The computer of claim 1, wherein the one or more input sources comprises one or more user applications, or an operating system.

22. The computer of claim 1, wherein the one or more input sources comprises information identifying a name, type or function of one or more user applications hosted on the computer, and wherein the mode switching logic is configured to select the particular operating mode for the LCD based on the name, type or function of the one or more user applications.

23. The computer of claim 1, wherein the one or more input sources comprises information identifying a name, type or function of a selected window of a graphical user interface hosted on the computer, and wherein the mode switching logic is configured to select the particular operating mode for the LCD based on the name, type or function of the selected window.

24. The computer of claim 1, wherein the one or more input sources comprises information identifying a video user application hosted on the computer, and wherein the mode switching logic is configured to select in response the transmissive mode as the particular operating mode.

25. The computer of claim 1, wherein the one or more input sources comprises information identifying a document reading application hosted on the computer, and wherein the mode switching logic is configured to select in response a grayscale mode or a resolution enhancement of the LCD as the particular operating mode.

26. The computer of claim 1, wherein the one or more input sources comprises information identifying a color image display application hosted on the computer, and wherein the mode switching logic is configured to select in response the transmissive mode or the transflective mode as the particular operating mode.

27. The computer of claim 1, wherein the one or more input sources comprises information indicating that the user applications hosted on the computer are displaying both first output with limited color content and second output comprising grayscale text or data, and wherein the mode switching logic is configured to select in response the transflective mode as the particular operating mode.

28. The computer of claim 1 wherein the computer is any one of a laptop computer, netbook computer, cellular radiotelephone, electronic book reader, point of sale terminal, desktop computer, computer workstation, computer kiosk, or computer coupled to or integrated into a gasoline pump.

29. The computer of claim 1, wherein the LCD is configured to permit individual addressing of transmissive sub pixel portions and reflective sub pixel portions of pixels of the LCD, wherein the one or more input sources comprises information indicating that the user applications hosted on the computer are displaying both first output with limited color content and second output comprising grayscale text or data, and wherein the mode switching logic is configured in response to cause driving a first part of the LCD in the transflective mode and a second part of the LCD in the reflective mode.

30. The computer of claim 1, wherein the mode switching logic is configured to delay causing the LCD to operate in the particular operational mode until after the LCD has completed displaying a current frame.

31. A computer-implemented process comprising:
receiving one or more of input signals at a computer comprising a liquid crystal display (LCD) operable in a transmissive mode, a reflective mode, and a transflective mode; one or more processors coupled to the LCD; one or more electronic input sources providing the input signals that represent states of ambient conditions, other computer elements, user input, or user applications of the computer;
based on the input signals, selecting a particular operational mode for the LCD from among the transmissive mode, the reflective mode, and the transflective mode;
causing the LCD to operate in the particular operational mode.

32. The process of claim 31, comprising receiving a backlight intensity state value and the one or more input signals indicating turning off a backlight of the LCD, and causing the LCD to operate in reflective mode.

33. The process of claim 31, wherein the one or more input sources comprises an ambient light sensor (ALS), and comprising receiving the input signals from the ALS indicating bright ambient light, determining that a current operating mode of the LCD is the transmissive or transflective mode, and in response to the input signals and the current operating mode, selecting and causing the LCD to operate in the reflective mode.

34. The process of claim 31, wherein the one or more input sources comprises an ambient light sensor (ALS), and comprising receiving the input signals from the ALS indicating moderately bright ambient light, determining that a current operating mode of the LCD is the transmissive mode or reflective mode, and in response to the input signals and the current operating mode, selecting and causing the LCD to operate in the transflective mode and to cause setting a backlight of the LCD to moderate brightness.

35. The process of claim 31, wherein the one or more input sources comprises an ambient light sensor (ALS), and comprising modifying image data for one or more images displayed on the LCD in response to changes in ambient light as indicated by the input signals.

36. The process of claim 31, wherein the one or more input sources comprises a power management subsystem, and comprising receiving the input signals from the power management system indicating a minimum power configuration, determining that a current operating mode of the LCD is the transmissive or transflective mode, and in response to the input signals and the current operating mode, selecting and causing the LCD to operate in the reflective mode.

37. The process of claim 31, wherein the one or more input sources comprises a power management subsystem, and comprising receiving the input signals from the power management system indicating operation on battery power, determining that a current operating mode of the LCD is the transmissive or transflective mode, and in response to the input signals and the current operating mode, selecting and causing the LCD to operate in the reflective mode.

38. The process of claim 30, further comprising causing a change in a refresh rate of the LCD.

39. The process of claim 31, wherein the one or more input sources comprises one or more values in non-volatile mode recall memory, and comprising determining that the process has restarted, is restarting, has completed bootstrap loading or is in a bootstrap loading process, and in response, fetching the values from the mode recall memory, to determine a previous operating mode of the LCD from the values, and to cause the LCD to operate in the previous operating mode.

40. The process of claim 31, wherein the one or more input sources comprises one or more user applications, or an operating system.

41. The process of claim 31, wherein the one or more input sources comprises information identifying a name, type or function of one or more user applications hosted on the process, and comprising selecting the particular operating mode for the LCD based on the name, type or function of the one or more user applications.

42. The process of claim 31, wherein the one or more input sources comprises information identifying a name, type or function of a selected window of a graphical user interface hosted on the process, and comprising selecting the particular operating mode for the LCD based on the name, type or function of the selected window.

43. The process of claim 31, wherein the LCD is configured to permit individual addressing of transmissive sub pixel portions and reflective sub pixel portions of pixels of the LCD, wherein the one or more input sources comprises information indicating that the user applications hosted on the process are displaying both first output with limited color content and second output comprising grayscale text or data, and comprising driving a first part of the LCD in the transflective mode and a second part of the LCD in the reflective mode.
